(19) United States
(12) Patent Application Publication
(10) Pub. No.: US 2026/0300395 A1
(43) Pub. Date: Oct. 1, 2026

(54) COLLATION DEVICE, COLLATION METHOD, AND MEDIUM

(71) Applicant: NEC Corporation, Tokyo (JP)

(72) Inventor: Takuya OGAWA, Tokyo (JP)

(73) Assignee: NEC Corporation, Tokyo (JP)

(21) Appl. No.: 19/477,178

(22) PCT Filed: May 22, 2023
(86) PCT No.: PCT/JP2023/018944

§ 371 Date: Oct. 21, 2025

(51) Int. Cl. G06F 16/901

(52) U.S. Cl. CPC G06F 16/901

(57) ABSTRACT

A collation device according to the present disclosure includes: a memory configured to store instructions; and one or more processors configured to execute the instructions to: update a parameter that defines a frequency distribution of one or a plurality of indexes relating to an object indicated by target data; calculate reliability of each of the indexes, using the parameter; and collate the object, based on the reliability.

### TECHNICAL FIELD

The present invention relates to a collation device, a collation method, and a program for collating an object.

### BACKGROUND ART

A technique for collating objects included in each of a plurality of images is known.

PTL 1 discloses an object tracking method that sets a region where a moving body in a processing target frame is imaged, as a tracking target region. In the object tracking method, the tracking target region of a following frame is corrected by pattern matching between the tracking target region set in a past frame prior to the processing target frame and the following frame.

### CITATION LIST

### Patent Literature

PTL 1: JP 2006-323437 A

### SUMMARY OF INVENTION

### Technical Problem

In the object tracking method described in PTL 1, it is not assumed that a condition under which the moving body (object) is imaged changes. For example, when a condition under which the moving body is imaged changes between the processing target frame and the following frame, a correlation value of the moving body between the frames decreases, and the accuracy of pattern matching decreases. Meanwhile, in a case where pattern matching is performed even though the correlation value is low, a recall rate decreases. That is, the object tracking method described in PTL 1 has a difficulty that it is not feasible to improve the recall rate while maintaining the accuracy of object collation.

One mode of the present invention has been made in view of the above difficulties, and an exemplary object of the present invention is to provide a technique for improving a recall rate while maintaining accuracy of object collation.

### Solution to Problem

A collation device according to one aspect of the present invention includes an updating means for updating a parameter that defines a frequency distribution of one or a plurality of indexes relating to an object indicated by target data, a reliability calculation means for calculating reliability of each of the indexes, using the parameter, and a collation means for collating the object, based on the reliability.

A collation method according to one aspect of the present invention includes, by a collation device, updating a parameter that defines a frequency distribution of one or a plurality of indexes relating to an object indicated by target data, calculating reliability of each of the indexes, using the parameter, and collating the object, based on the reliability.

A program according to one aspect of the present invention causes a computer to execute an updating process of updating a parameter that defines a frequency distribution of one or a plurality of indexes relating to an object indicated by target data, a reliability calculation process of calculating reliability of each of the indexes, using the parameter, and a collation process of collating the object, based on the reliability.

### Advantageous Effects of Invention

According to one mode of the present invention, a recall rate can be improved while accuracy of object collation is maintained.

### BRIEF DESCRIPTION OF DRAWINGS

FIG. 1 is a block diagram illustrating a configuration of a collation device according to a first example embodiment of the present invention.

FIG. 2 is a flowchart illustrating a flow of a collation method according to the first example embodiment of the present invention.

FIG. 3 is a block diagram illustrating a configuration of a collation device according to a second example embodiment of the present invention.

FIG. 4 is a diagram illustrating an example of frequency distributions of indexes 1 to 3 according to the second example embodiment of the present invention.

FIG. 5 is a flowchart illustrating a flow of a collation method according to the second example embodiment of the present invention.

FIG. 6 is a flowchart illustrating a flow of an object collation process according to the second example embodiment of the present invention.

FIG. 7 is a flowchart illustrating a flow of a reliability calculation process according to the second example embodiment of the present invention.

FIG. 8 is a flowchart illustrating a flow of a parameter updating process according to the second example embodiment of the present invention.

FIG. 9 is a block diagram illustrating a hardware configuration example of the collation device according to each example embodiment of the present invention.

### EXAMPLE EMBODIMENT

### First Example Embodiment

A first example embodiment of the present invention will be described in detail with reference to the drawings. The present example embodiment is a basic form of the example embodiment to be described later.

### (Outline of Collation Device 1)

A collation device 1 according to the present example embodiment is a device that performs a collation process relating to one or a plurality of objects. Here, the collation device 1 can determine whether a plurality of objects is objects corresponding to each other. The collation device 1 can also compare each object with collation data and determine whether each object is an object consistent with the compared collation data.

In the present description, in a case where a first object and a second object are corresponding objects, these objects may sometimes be expressed as, for example, “the same” or “coincide with each other”. Also in a case where the first object and the second object are objects that are acceptable to be regarded as the same, these objects may sometimes be expressed as, for example, “the same” or “coincide with each other”.

In the collation device 1, the objects that coincide with each other are managed by a same identifier (ID), in one example. For example, in a case where it is determined that an object detected in a certain frame and an object detected in a frame following the certain frame are the same object, the collation device 1 manages these objects in association with the same ID.

### (Configuration of Collation Device 1)

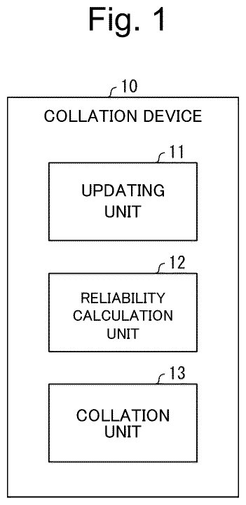

A configuration of the collation device 1 according to the present example embodiment will be described with reference to FIG. 1. FIG. 1 is a block diagram illustrating a configuration of the collation device 1 according to the present example embodiment.

As illustrated in FIG. 1, the collation device 1 includes an updating unit 11, a reliability calculation unit 12, and a collation unit 13. The updating unit 11, the reliability calculation unit 12, and the collation unit 13 have configurations to implement an updating means, a reliability calculation means, and a collation means, respectively, in the present example embodiment.

The updating unit 11 updates a parameter that defines a frequency distribution of one or a plurality of indexes relating to an object indicated by target data. The updating unit 11 supplies the updated parameter to the reliability calculation unit 12.

The target data is data to be subjected to a collation process by the collation device 1. The target data is not limited and may include image data, audio data, point cloud data, other sensing data, and the like, in one example.

The one or a plurality of indexes relating to the object may indicate an attribute relating to the object, or may numerically evaluate the attribute.

For example, in a case where the target data is image data, examples of the plurality of indexes include a color, a shape, and a pattern of the object in an image indicated by the image data.

The frequency distribution of the index is data obtained by classifying values of the index until then into specified ranges to indicate how many pieces of data fall within each range. In one example, in a case where the target data is image data including a plurality of frames, data indicating a relationship between a value of the index relating to an object included as a subject in each of 10 frames and the number of frames is exemplified.

The parameter that defines the frequency distribution of the index is a parameter used to calculate reliability to be described later. In other words, the parameter that defines the frequency distribution of the index is a parameter that defines a variation of the index. Examples of the parameter include a parameter expected to give a predetermined value of the reliability of the index at a certain value of the index.

The reliability calculation unit 12 calculates the reliability of each index, using the parameter supplied from the updating unit 11. The reliability calculation unit 12 supplies the calculated reliability to the updating unit 11.

The reliability is a value indicating to what extent the index is reliable in the collation. Examples of the reliability include a value indicating a difference between a certain object and a comparison target for the certain object. For example, it is assumed that the collation device 1 executes a process of tracking an object included as a subject in a moving image. In this case, the reliability indicating a difference in the certain index between an object included as a subject in an image captured temporally earlier and an object included as a subject in an image captured temporally later is used in collation.

For example, in a case where the collation device 1 executes a process of comparing the collation data provided in advance with an object, the reliability indicating a difference between a feature indicated by the collation data and a feature of the object is used in collation.

Another example of the reliability is a value indicating how similar a certain object is to a comparison target for the certain object.

The collation unit 13 collates the object, based on the reliability supplied from the reliability calculation unit 12. For example, the collation unit 13 collates the object indicated by the target data by comparing the reliability with a threshold value.

As described above, the collation device 1 according to the present example embodiment adopts a configuration including the updating unit 11 that updates a parameter that defines the frequency distribution of one or a plurality of indexes relating to an object indicated by the target data, the reliability calculation unit 12 that calculates the reliability of each index, using the parameter supplied from the updating unit 11, and the collation unit 13 that collates the object, based on the reliability supplied from the reliability calculation unit 12.

In this manner, the collation device 1 according to the present example embodiment updates the parameter for calculating the reliability used for collation and performs collation, using the updated parameter. Therefore, according to the collation device 1 according to the present example embodiment, an effect of improving the recall rate while maintaining the accuracy of object collation can be obtained.

### (Flow of Collation Method S1)

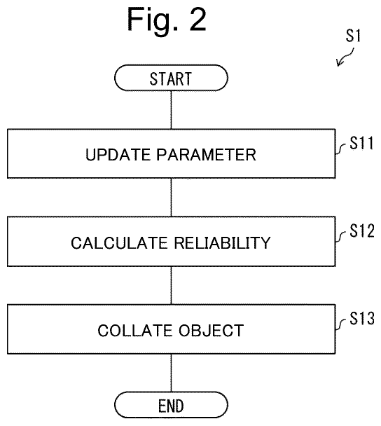

A flow of a collation method S1 according to the present example embodiment will be described with reference to FIG. 2. FIG. 2 is a flowchart illustrating a flow of the collation method S1 according to the present example embodiment.

### (Step S11)

In step S11, the updating unit 11 updates a parameter that defines a frequency distribution of one or a plurality of indexes relating to an object indicated by target data. The updating unit 11 supplies the updated parameter to the reliability calculation unit 12.

### (Step S12)

In step S12, the reliability calculation unit 12 calculates the reliability of each index, using the parameter supplied from the updating unit 11. The reliability calculation unit 12 supplies the calculated reliability to the updating unit 11.

### (Step S13)

In step S13, the collation unit 13 collates the object, based on the reliability supplied from the reliability calculation unit 12.

As described above, the collation method S1 according to the present example embodiment adopts a configuration including step S11 in which the updating unit 11 updates a parameter that defines a frequency distribution of one or a plurality of indexes relating to an object indicated by the target data, step S12 in which the reliability calculation unit 12 calculates the reliability of each index, using the parameter supplied from the updating unit 11, and step S13 in which the collation unit 13 collates the object, based on the reliability supplied from the reliability calculation unit 12. Therefore, according to the collation method S1 according to the present example embodiment, an effect similar to that of the above-described collation device 1 can be obtained.

### Second Example Embodiment

A second example embodiment of the present invention will be described in detail with reference to the drawings. Components having the same functions as the components described in the first example embodiment will be denoted by the same reference signs, and the description thereof will be omitted as appropriate.

### (Outline of Collation Device 20)

A collation device 20 is a device that performs a collation process relating to one or a plurality of objects, similarly to the collation device 1 described above. In the present example embodiment, the collation device 20 acquires image data including a plurality of frames, as target data, in one example. The collation device 20 then determines whether one or a plurality of objects included as a subject in a certain frame (in other words, one or a plurality of objects indicated by the target data) coincide with one or a plurality of objects included as a subject in an immediately preceding frame. Examples of the object include air bubbles included as subjects in an image obtained by imaging a liquid contained in a bin, and a person included as a subject in an image obtained by imaging a city.

Hereinafter, an object included as a subject in a certain frame will be referred to as a “candidate object”, and an object that is included as a subject in a past frame prior to the certain frame and is highly likely to correspond to the candidate object will be referred to as a “collation target object”.

### (Configuration of Collation Device 20)

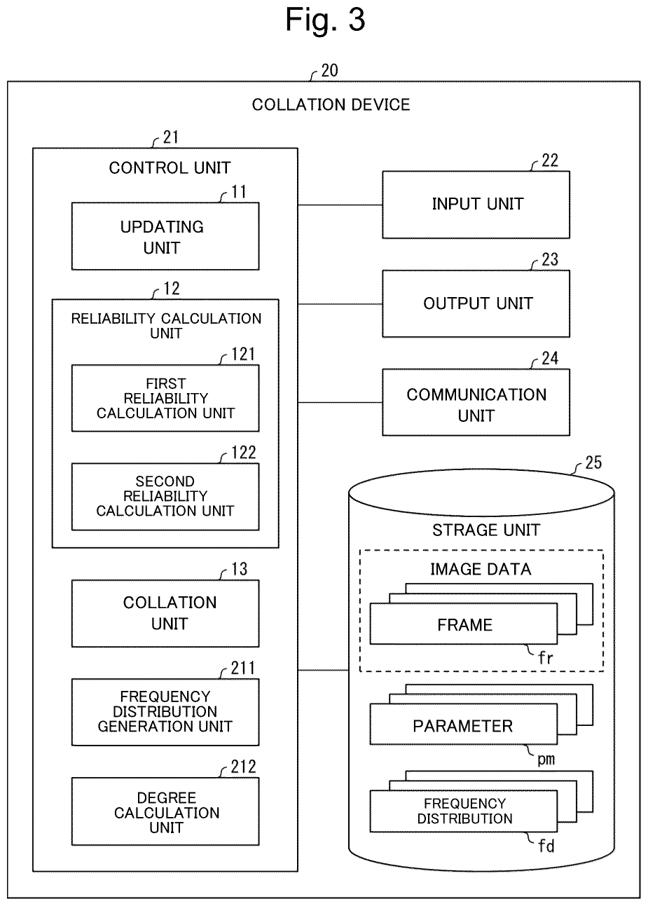

FIG. 3 is a block diagram illustrating a configuration of the collation device 20 according to the present example embodiment. As illustrated in FIG. 3, the collation device 20 according to the present example embodiment includes a control unit 21, an input unit 22, an output unit 23, a communication unit 24, and a storage unit 25.

The input unit 22 accepts various sorts of inputs to the collation device 20. The input unit 22 supplies data indicating the accepted inputs to the control unit 21.

A specific configuration of the input unit 22 does not limit the present example embodiment, but in one example, a configuration including an input device such as a keyboard or a touch pad can be employed. The input unit 22 may have a configuration including a data scanner that reads data via electromagnetic waves such as infrared rays and radio waves, a sensor that senses the state of the environment, and the like.

The output unit 23 is a functional block that outputs a processing result by the collation device 20. The output unit 23 outputs data supplied from the control unit 21.

A specific configuration of the output unit 23 does not limit the present example embodiment, but in one example, is configured by a display, a speaker, a printer, or the like. In this case, the output unit 23, for example, displays various sorts of processing results and the like by the collation device 20 on a screen, or outputs various sorts of processing results and the like as sound or a diagram.

The communication unit 24 is an interface for connecting the collation device 20 to a network. The communication unit 24, for example, sends data supplied from the control unit 21 to another device via a network and supplies data sent from another device via a network to the control unit 21.

A specific configuration of the network does not limit the present example embodiment, but in one example, a wireless local area network (LAN), a wired LAN, a wide area network (WAN), a public line network, a mobile data communication network, or a combination of these networks can be used.

The storage unit 25 stores data to be referred to by the control unit 21. The storage unit 25 is constituted by a semiconductor memory device or the like, for example. In one example, as illustrated in FIG. 3, the storage unit 25 stores image data including a plurality of frames fr that is the target data, a parameter pm of each of one or a plurality of indexes relating to an object, and a frequency distribution fd of each of the one or a plurality of indexes relating to the object.

The parameter pm of each index and the frequency distribution fd of each index stored in the storage unit 25 are associated with each other. That is, a certain parameter pm stored in the storage unit 25 is a parameter pm that defines a certain frequency distribution fd associated with the certain parameter pm.

The frequency distribution fd stored in the storage unit 25 before the collation device 20 starts collation is a frequency distribution fd generated based on a plurality of frames acquired in advance and data relating to an object (for example, a position, a speed, and the like of an object) included as a subject in each of the plurality of frames. The plurality of frames and the data acquired in advance will also be referred to as ground truth information. The frequency distribution fd generated from the ground truth information will also be referred to as initial information. A process of generating the initial information will be described later.

The parameter pm stored in the storage unit 25 before the collation device 20 starts collation is a parameter that defines the initial information. The parameter pm and the frequency distribution fd stored in the storage unit 25 before the collation device 20 starts collation are not limited and may be, for example, a predetermined parameter pm and a predetermined frequency distribution fd.

In a case where the collation device 20 executes collation and a predetermined condition is satisfied, the frequency distribution fd and the parameter pm defining the frequency distribution fd stored in the storage unit 25 are updated by an updating unit 11 to be described later.

### (Function of Control Unit 21)

The control unit 21 controls each component included in the collation device 20. In one example, the control unit 21 stores the frame fr supplied from the communication unit 24 in the storage unit 25. In another example, the control unit 21 supplies a collation result by a collation unit 13 to be described later to at least one of the output unit 23 and the communication unit 24.

The control unit 21 detects an object included as a subject in the frame fr. In one example, the control unit 21 may detect an object by image processing such as existing object extraction processing. In another example, the control unit 21 may detect an object, using a model trained by machine learning in such a way as to output an object included as a subject in a frame with the frame as an input.

For example, the object can be detected by a graph cutting method. In the graph cutting method, first, a boundary of a region that constitutes a foreground object image including an object desired to be cut out and is intended to be cut out is computed from a color distribution and a pixel color gradient of two types of images made up of the foreground object image and a background image. An image is then cut out along the computed boundary, whereby the foreground object image desired to be cut out is extracted.

The control unit 21 puts a rectangular frame (bounding box) indicating the detection to the detected object. The control unit 21 also puts an authentication number (hereinafter, also referred to as “ID”) to each of the objects extracted from the frame fr. In one example, the control unit 21 puts the ID in association with the bounding box.

As illustrated in FIG. 3, the control unit 21 includes the updating unit 11, a reliability calculation unit 12, the collation unit 13, a frequency distribution generation unit 211, and a degree calculation unit 212. The updating unit 11, the reliability calculation unit 12, the collation unit 13, the frequency distribution generation unit 211, and the degree calculation unit 212 have configurations to implement the updating means, the reliability calculation means, the collation means, an initial information generation means, and a degree calculation means, respectively, in the present example embodiment.

The updating unit 11 calculates the parameter pm that defines the frequency distribution fd of an index relating to an object included as a subject in the frame fr. The object, the index, the frequency distribution fd, and the parameter pm are as described above.

In one example, the updating unit 11 calculates the parameter pm from the initial information stored in the storage unit 25. The updating unit 11 stores the calculated parameter pm in the storage unit 25.

In another example, the updating unit 11 updates the parameter pm stored in the storage unit 25 from the parameter defining the past frequency distribution fd (including the initial information) stored in the storage unit 25 to the parameter pm defining the current frequency distribution fd. The updating unit 11 also updates the past frequency distribution fd stored in the storage unit 25 to the current frequency distribution fd. The past frequency distribution and the current frequency distribution will be described later.

The updating unit 11 may update the parameter pm in a case where a predetermined condition is satisfied. In one example, in a case where the collation unit 13 to be described later removes the reliability of at least one index among the plurality of indexes to collate the object, the updating unit 11 may update the parameter pm that defines the frequency distribution of the removed at least one index.

Furthermore, in a case where a degree calculated by the degree calculation unit 212 to be described later is smaller than a threshold value, the updating unit 11 may update the parameter pm from the parameter pm defining the past frequency distribution to the parameter pm defining the current frequency distribution.

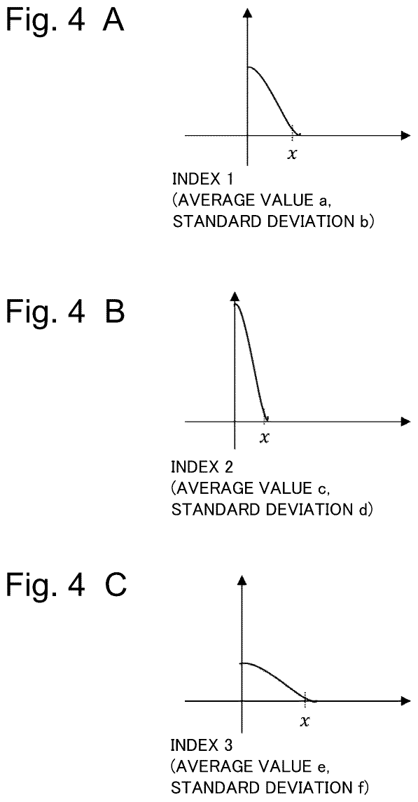

An example of a process executed by the updating unit 11 will be described with reference to FIG. 4. FIG. 4 is a diagram illustrating an example of the frequency distributions fd of indexes 1 to 3 according to the present example embodiment.

FIG. 4 illustrates the frequency distributions fd of the indexes 1 to 3 having different average values and different standard deviations from each other. In the frequency distributions fd illustrated in FIG. 4, the horizontal axis indicates a difference between the value of the index of the collation target object and the value of the index of the candidate object in a plurality of frames (for example, 10 frames). The vertical axis indicates the frequency (the number of frames).

In one example, in the frequency distributions fd of the indexes 1 to 3, the updating unit 11 calculates a parameter k that gives reliability (e^{-kx}) of 0.6 at a value x on the horizontal axis including 99% of the frequency. In this manner, the updating unit 11 can suppress a variation of each of the indexes 1 to 3 having different frequency distributions by updating the parameter k in such a way that the reliability has a predetermined value at values having a difference (“x” in the above-described example).

The reliability calculation unit 12 calculates the reliability (first reliability and second reliability) of each index, using the parameter pm stored in the storage unit 25. The reliability calculation unit 12 supplies the calculated second reliability to the collation unit 13. As illustrated in FIG. 3, the reliability calculation unit 12 includes a first reliability calculation unit 121 and a second reliability calculation unit 122.

The first reliability calculation unit 121 calculates the first reliability of each of one or a plurality of indexes relating to the candidate object included as a subject in the frame fr. For example, the first reliability calculation unit 121 calculates a difference x between each of a color, a size, a position, and a speed that are indexes of the candidate object included as a subject in the frame fr, and each of a color, a size, a position, and a speed of the collation target object that is a comparison target for the candidate object, and employs the reliability (e-kx, where k is a value of the parameter pm) as the first reliability. The first reliability calculation unit 121 supplies the calculated first reliability to the second reliability calculation unit 122.

The second reliability calculation unit 122 calculates one or multiple pieces of the second reliability from one or multiple pieces of the first reliability. In one example, the second reliability calculation unit 122 calculates the second reliability by applying a predetermined arithmetic operation to one or multiple pieces of the first reliability. The second reliability calculation unit 122 supplies the calculated second reliability to the collation unit 13.

For example, the second reliability calculation unit 122 may calculate a product of some multiple pieces of the first reliability calculated by the first reliability calculation unit 121, as the second reliability. In this case, the second reliability calculation unit 122 calculates multiple pieces of the second reliability by excluding at least one piece of the first reliability, among the multiple pieces of the first reliability calculated by the first reliability calculation unit 121, from the target multipliers of the product.

For example, in a case where it is supposed that the first reliability relating to the color of the object is r11, the first reliability relating to the shape of the object is r12, and the first reliability relating to the pattern of the object is r13, the second reliability calculation unit 122 calculates the following pieces of the second reliability R21, R22, and R23.

$$R 21 = r 11 * r 12 , R 22 = r 11 * r 13 , R 23 = r 12 * r 13$$

The second reliability calculation unit 122 may calculate, as the second reliability, a value obtained by performing an arithmetic operation on the multiple pieces of the first reliability calculated by the first reliability calculation unit 121 with a predetermined exponent and then multiplying the resulting multiple pieces of the first reliability by each other. In this case, the second reliability calculation unit 122 calculates multiple pieces of the second reliability by applying a plurality of combinations of exponents to the multiple pieces of the first reliability.

In a case where the first reliability calculation unit 121 has calculated one piece of the first reliability, the second reliability calculation unit 122 may employ the first reliability calculated by the first reliability calculation unit 121 as the second reliability.

The collation unit 13 collates the object, based on the second reliability supplied from the reliability calculation unit 12 (the second reliability calculation unit 122). In one example, the collation unit 13 collates the object by comparing the second reliability with a threshold value. In another example, in a case where the pieces of the second reliability R21, R22, and R23 described above are employed as the second reliability, the collation unit 13 compares one of the pieces of the second reliability R21, R22, and R23 with the threshold value to collate the object.

In a case where the second reliability is higher than the threshold value, the collation unit 13 outputs a collation result that the candidate object corresponds to the collation target object. In one example, the collation unit 13 outputs a collation result in which an ID is associated with the bounding box containing the object.

The frequency distribution generation unit 211 generates the frequency distribution fd from the frame fr. In one example, the frequency distribution generation unit 211 generates the initial information that is a past frequency distribution, from a past frame before the collation device 20 executes collation.

For example, the frequency distribution generation unit 211 calculates values of a position error, a size error, and a speed error, and the like of the object between each frame, from the ground truth information that is a plurality of past frames and the data of the object. The frequency distribution generation unit 211 calculates values of the position error, the size error, the speed error, and the like in each index and generates an average value, a standard deviation, and the like, and initial information that is the frequency distribution fd. The frequency distribution generation unit 211 stores the generated initial information in the storage unit 25.

With this configuration, the collation device 20 can set an appropriate parameter pm as an initial value before starting collation.

In another example, after the collation, the frequency distribution generation unit 211 generates the current frequency distribution fd including the value of the index relating to the candidate object. For example, as the current frequency distribution fd, the frequency distribution generation unit 211 generates the frequency distribution fd for the last 10 frames including a frame including the candidate object as a subject. Specifically, the frequency distribution generation unit 211 adds the value of the candidate object to the frequency distribution for 9 frames immediately before the frame including the candidate object as a subject and generates the current frequency distribution fd for 10 frames. The frequency distribution generation unit 211 supplies the generated frequency distribution fd of the target data to the updating unit 11 and the degree calculation unit 212.

For at least one index removed by the second reliability calculation unit 122, the degree calculation unit 212 calculates a degree indicating the strength of association between the past frequency distribution and the current frequency distribution. The degree calculation unit 212 calculates a degree indicating the strength of association between the frequency distribution fd stored in the storage unit 25 and the latest frequency distribution fd supplied from the frequency distribution generation unit 211.

In one example, the degree calculation unit 212 calculates the degree indicating the strength of association, using the average value and the standard deviation of the frequency distribution fd stored in the storage unit 25 and the average value and the standard deviation of the latest frequency distribution fd supplied from the frequency distribution generation unit 211. The degree calculation unit 212 also calculates an effect size of the r-family, as the strength of association. The effect size of the r-family is a normalized value and can be used even in a situation where the number of data samples is small. The degree calculation unit 212 supplies the calculated degree to the updating unit 11.

### (Flow of Collation Method S2 Executed by Collation Device 20)

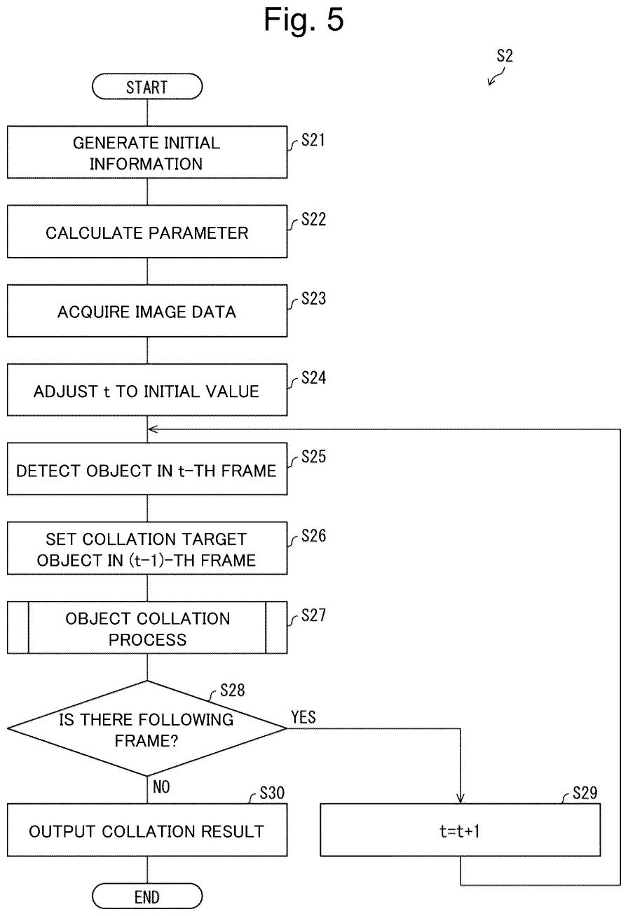

A flow of a collation method S2 executed by the collation device 20 will be described with reference to FIG. 5. FIG. 5 is a flowchart illustrating a flow of the collation method S2 according to the present example embodiment.

### (Step S21)

In step S21, the frequency distribution generation unit 211 generates the frequency distribution fd that is initial information on each index. The frequency distribution generation unit 211 stores the initial information on each index in the storage unit 25.

### (Step S22)

In step S22, the updating unit 11 calculates the parameter pm of each index from the initial information on each index stored in the storage unit 25. The updating unit 11 stores the calculated parameter pm in the storage unit 25.

### (Step S23)

In step S23, the control unit 21 acquires image data including a plurality of frames fr. The control unit 21 stores the image data in the storage unit 25.

### (Step S24)

In step S24, the control unit 21 sets the value of a variable t to an initial value.

### (Step S25)

In step S25, the control unit 21 detects an object in a t-th frame. Since the specific object detection process has been described above, description thereof will be omitted here.

### (Step S26)

In step S26, the control unit 21 sets the collation target object in a (t−1)-th frame. Here, the collation target object is an object to be collated this time, among objects displayed in the image of the (t−1)-th frame. In a case where the image of the (t−1)-th frame contains a plurality of collation target objects, processing described below is repeatedly executed in relation to every collation target object.

### (Step S27)

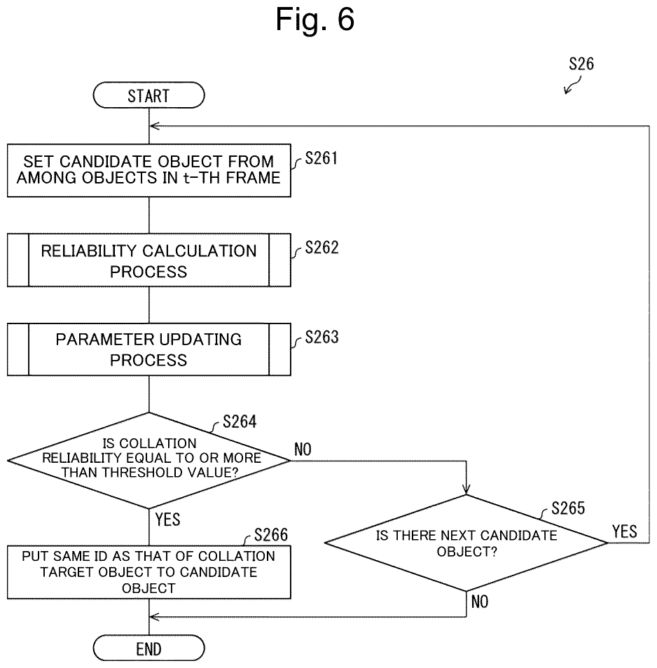

In step S27, the control unit 21 executes an object collation process. Details of the object collation process will be described later with reference to FIG. 6.

### (Step S28)

In step S28, the control unit 21 determines whether the image data acquired in step S23 has a following frame.

### (Step S29)

In a case where it is determined in step S28 that there is a following frame (step S28: YES), in step S29, the control unit 21 sets the value of the variable t to t+1. Thereafter, the control unit 21 executes the process in step S25.

### (Step S30)

In a case where it is determined in step S28 that there is no following frame (step S28: NO), the control unit 21 outputs a collation result.

In this manner, in the collation method S2, it is determined whether the object included as a subject in the t-th frame corresponds to the object included as a subject in the (t−1)-th frame.

### (Flow of Object Collation Process)

A flow of the object collation process in step S26 mentioned above will be described with reference to FIG. 6. FIG. 6 is a flowchart illustrating a flow of the object collation process according to the present example embodiment.

### (Step S261)

In step S261, the control unit 21 sets a candidate object from among objects in the t-th frame. The candidate object is an object that is highly likely to be the same as the collation target object detected in the process in step S25 in FIG. 5. In one example, the control unit 21 calculates coordinates of a position where the collation target object included as a subject in the image of the (t−1)-th frame is detected. The control unit 21 then sets an object positioned within a particular range of distance centered on those coordinates in the t-th frame, as a candidate object.

### (Step S262)

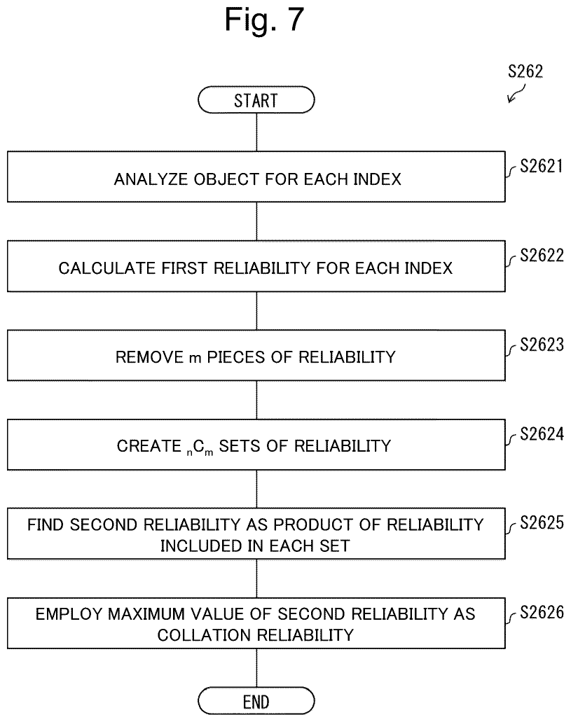

In step S262, the reliability calculation unit 12 executes a reliability calculation process. The reliability calculation unit 12 supplies the second reliability calculated in step S262 to the collation unit 13 as collation reliability. Details of the reliability calculation process will be described later with reference to FIG. 7.

### (Step S263)

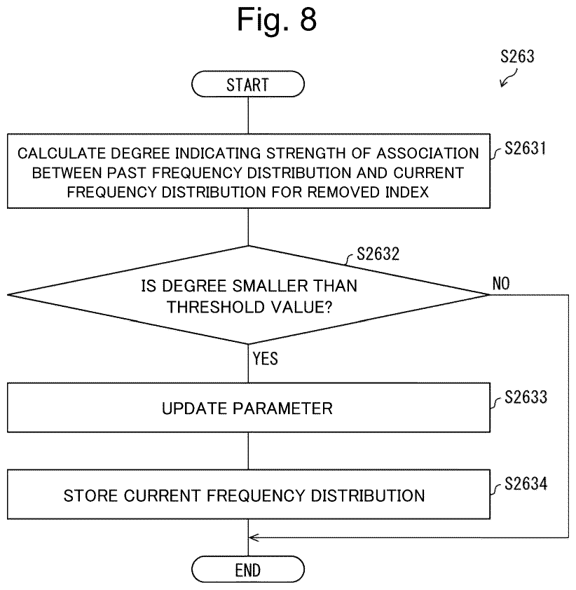

In step S263, the updating unit 11 executes a parameter updating process. Details of the parameter updating process will be described later with reference to FIG. 8.

### (Step S264)

In step S264, the collation unit 13 determines whether the collation reliability is equal to or more than a threshold value.

### (Step S265)

In a case where it is determined in step S264 that the collation reliability is not equal to or more than the threshold value (step S264: NO), in step S265, the control unit 21 determines whether there is a next candidate object.

In a case where it is determined in step S265 that there is a next candidate object (step S265: YES), the next candidate object is set in step S261.

On the other hand, in a case where it is determined in step S265 that there is no next candidate object (step S265: NO), the control unit 21 ends the object collation process.

### (Step S266)

In a case where it is determined in step S264 that the collation reliability is equal to or more than the threshold value (step S264: YES), in step S266, the control unit 21 puts the same ID as that of the collation target object, to the candidate object.

In this manner, in the object collation process, the object collation process for the next candidate object is executed using the parameter pm updated in the parameter updating process.

(Flow of Reliability Calculation Process) FIG. 7 is a flowchart illustrating a flow of the reliability calculation process according to the present example embodiment.

### (Step S2621)

In step S2621, the first reliability calculation unit 121 analyzes the collation target object and the candidate object for each index. Here, the indexes may be a color, a shape, a pattern, and a speed of the object. Alternatively, a position, a size, acceleration, and the like of the object may be employed as indexes.

In a case where the indexes are the color, shape, pattern, and speed of the object, the first reliability calculation unit 121 calculates, for example, an average value or the like of pixel values of the collation target object and the candidate object with respect to the index “color”. The first reliability calculation unit 121 finds, for example, a shape or the like to which the contours of the collation target object and the candidate object are approximate, with respect to the index “shape”. Furthermore, for example, the first reliability calculation unit 121 detects an edge in the collation target object and the candidate object with respect to the index “pattern”.

For example, with respect to the index “speed”, a moving distance and a moving direction between one frame of the collation target object and one frame of the candidate object are specified. The moving distance and the moving direction of the collation target object have been specified in advance with reference to the frame of the collation target object and a frame preceding that frame, and the speed of the collation target object has also been calculated. The moving distance and the moving direction of the candidate object are found on the assumption that the collation target object is the same as the candidate object.

Information for specifying what is employed as an index, what kind of arithmetic operation is to be done for the first reliability, and the like (hereinafter, also referred to as “information regarding the index”) may be set in advance, or may be input via the communication unit 24 or the input unit 22. Alternatively, the information regarding the index may be provided as metadata or the like included in the image data as target data.

In one example, index information in which the information regarding the index is described is stored in the storage unit 25, and the first reliability calculation unit 121 does an arithmetic operation for the first reliability with reference to the index information stored in the storage unit 25. The first reliability calculation unit 121 acquires the information regarding the index and calculates the first reliability, based on the acquired information regarding the index.

### (Step S2622)

In step S2622, the first reliability calculation unit 121 calculates the first reliability for each index. For example, in a case where the indexes are the color, shape, pattern, and speed of the object, the first reliability calculation unit 121 calculates the first reliability from differences in the color, shape, pattern, and speed between the collation target object and the candidate object. Since there is a plurality of indexes, a plurality of (for example, n) pieces of the first reliability will be calculated in step S2622.

### (Step S2623)

In step S2623, the second reliability calculation unit 122 removes any m pieces of reliability from n pieces of the first reliability calculated in step S2622. Here, m is supposed to be a natural number less than n.

### (Step S2624)

In step S2624, the second reliability calculation unit 122 creates ₙCₘ sets of reliability. For example, in a case where the number of indexes is four and one piece of reliability is removed in step S2622, ₄C₁=4 sets will be obtained because n is 4 and m is 1.

More specifically, it is supposed that first reliability a, first reliability b, first reliability c, and first reliability d have been calculated for an index A, an index B, an index C, and an index D, respectively. In this case, four sets of (a, b, c), (a, b, d), (a, c, d), and (b, c, d) are obtained in step S2624.

### (Step S2625)

In step S2625, the second reliability calculation unit 122 calculates the second reliability by finding the product of pieces of the first reliability included in each set obtained in step S2624. In a case of the above-described example, four pieces of the second reliability of M1=a*b*c, M2=a*b*d, M3=a*c*d, and M4=b*c*d will be found. Here, “*” indicates an arithmetic operation representing a product.

In this manner, for each of the ₙCₘ sets obtained by removing any m (m is a natural number less than n) pieces of the first reliability from n (n is a natural number equal to or more than two) pieces of the first reliability, the second reliability calculation unit 122 calculates the second reliability relating to each of the ₙCₘ sets by taking the product of all pieces of the first reliability included in each set.

### (Step S2626)

In step S2626, the collation unit 13 employs a maximum value max(M1, M2, M3, M4) of the second reliability calculated in step S2625, as the collation reliability. That is, the collation unit 13 collates the object, based on the second reliability having a maximum value, among multiple pieces of the second reliability.

In this manner, in the reliability calculation process, the second reliability is calculated from the first reliability calculated using the updated parameter.

### (Another Example of Method for Calculating Second Reliability)

In the above-described example, it has been described that in step S2623, any m pieces of reliability are removed from among the n pieces of the first reliability found in step S2622. However, instead of removing any m pieces of reliability, the second reliability calculation unit 122 may perform an exponential arithmetic operation with a value larger than zero but smaller than one as an exponent number on any m (m is a natural number less than n) pieces of the first reliability.

For example, since the value of the first reliability becomes one by performing an exponential arithmetic operation with the exponent number 0, an arithmetic operation with the exponent number 0 equivalent to removing the first reliability can be done when the product of the first reliability is found.

That is, for each of the ₙCₘ sets obtained by performing an exponential arithmetic operation with a value larger than zero but smaller than one as an exponent number on any m (m is a natural number less than n) pieces of the first reliability among n (n is a natural number equal to or more than two) pieces of the first reliability, the first reliability calculation unit 121 calculates the second reliability relating to each of the ₙCₘ sets by taking the product of all pieces of the first reliability included in each set. The collation unit 13 may then collate the object, based on the second reliability having a maximum value among pieces of second reliability relating to each of the ₙCₘ sets.

Specifically, it is assumed that first reliability a, first reliability b, first reliability c, and first reliability d have been calculated for an index A, an index B, an index C, and an index D, respectively. In this case, the second reliability calculation unit 122 may set (exponent to be applied to a, exponent to be applied to b, exponent to be applied to c, exponent to be applied to d) to (1, 1, 1, α), (1, 1, α, 1), (1, α, 1, 1), and (α, 1, 1, 1).

Here, a is a real number larger than zero but smaller than one. The second reliability calculation unit 122 may calculate the second reliability by performing exponential arithmetic operations with these exponents on its related pieces of the first reliability and then taking the products of the first reliability after the exponential arithmetic operations.

More specifically, the second reliability calculation unit 122 may calculate multiple pieces of the second reliability M1 to M4 by

$$M 1 = a * b * c * {d}^{α} \\ M 2 = a * b * {c}^{α} * d \\ M 3 = a * {b}^{α} * c * d \\ M 4 = {a}^{α} * b * c * d .$$

### (Flow of Parameter Updating Process)

A flow of the parameter updating process will be described with reference to FIG. 8. FIG. 8 is a flowchart illustrating a flow of the parameter updating process according to the present example embodiment.

### (Step S2631)

In step S2631, for the index removed in step S2623 described above, the degree calculation unit 212 calculates a degree indicating the strength of association between the past frequency distribution fd stored in the storage unit 25 and the current frequency distribution fd generated by the frequency distribution generation unit 211. The degree calculation unit 212 supplies the calculated degree to the updating unit 11.

### (Step S2632)

In step S2632, the updating unit 11 determines whether the degree supplied from the degree calculation unit 212 in step S2631 is smaller than a threshold value.

### (Step S2633)

In a case where it is determined in step S2632 that the degree is smaller than the threshold value (step S2632: YES), in step S2633, the updating unit 11 updates the parameter pm of the removed index. In other words, in a case where the association between the past frequency distribution fd and the current frequency distribution fd is weak, the updating unit 11 updates the parameter pm.

For example, it is assumed that the reliability of the index A is removed in step S2623 described above and the association between the past frequency distribution fd and the current frequency distribution fd of the index A is weak. In this case, in step S2633, the updating unit 11 updates the parameter pm of the index A from the parameter pm defining the past frequency distribution to the parameter pm defining the current frequency distribution.

### (Step S2634)

In step S2634, the updating unit 11 stores the current frequency distribution fd instead of the past frequency distribution fd stored in the storage unit 25.

On the other hand, in a case where it is determined in step S2632 that the degree is equal to or more than the threshold value (step S2632: NO), the control unit 21 ends the parameter updating process. Even in a case where it is determined that the degree is equal to or more than the threshold value, the updating unit 11 may execute the process in step S2634 (the process of storing the current frequency distribution fd instead of the past frequency distribution fd stored in the storage unit 25).

In this manner, the updating unit 11 updates the parameter pm that defines the frequency distribution of the index removed in step S2623 described above. The frequency distribution of the index removed in step S2623 described above may be unlikely to be suited to the frequency distribution of the index of the object included as a subject in the current frame. Therefore, with this configuration, the updating unit 11 can update the parameter pm to the parameter pm suitable for the object included as a subject in the current frame. With this configuration, the updating unit 11 also can reduce the processing load as compared with a case of updating the parameters pm of all the indexes.

In a case where the degree indicating the strength of association between the past frequency distribution and the current frequency distribution is smaller than the threshold value, the updating unit 11 updates the parameter pm from the parameter pm defining the past frequency distribution to the parameter pm defining the current frequency distribution. With this configuration, the updating unit 11 can update the parameter pm to the parameter pm suitable for the object included as a subject in the current frame.

### (Effects of Collation Device 20)

As described above, the collation device 20 according to the present example embodiment updates the parameter pm used to calculate the reliability of the index to the parameter pm that defines the frequency distribution suited to the object included as a subject in the current frame. Therefore, even for a plurality of frames captured under different imaging conditions, the collation device 20 improves the recall rate while maintaining the accuracy of collation of the object included as a subject in each of the plurality of frames.

### [Example of Implementation by Software]

Some or all of the functions of the collation devices 1 and 20 may be implemented by hardware such as an integrated circuit (IC chip) or may be implemented by software.

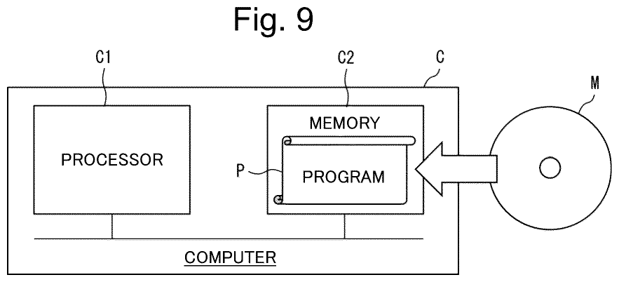

In the latter case, the collation devices 1 and 20 are implemented by, for example, a computer that executes a command of a program that is software for implementing each function. FIG. 9 illustrates an example of such a computer (hereinafter, expressed as a computer C). The computer C includes at least one processor C1 and at least one memory C2. A program P for causing the computer C to operate as the collation device 1 or 20 is recorded in the memory C2. In the computer C, each function of the collation device 1 or 20 is implemented by the processor C1 reading the program P from the memory C2 and executing the read program P.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof, or the like can be used. As the memory C2, for example, a flash memory, a hard disk drive (HDD), a solid state drive (SSD), or a combination thereof, or the like can be used.

The computer C may further include a random access memory (RAM) for loading the program P at the time of execution and temporarily storing various sorts of data, for example. The computer C may further include a communication interface for sending and receiving data to and from another device. The computer C may further include an input/output interface for connecting input/output equipment such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### [Supplementary Information 1]

The present invention is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present invention.

### [Supplementary Information 2]

Some or all of the above-described example embodiments may be described as follows. However, the present invention is not limited to the modes described below.

### (Supplementary Note 1)

A collation device including: an updating means for updating a parameter that defines a frequency distribution of one or a plurality of indexes relating to an object indicated by target data; a reliability calculation means for calculating reliability of each of the indexes, using the parameter; and a collation means for collating the object, based on the reliability.

### (Supplementary Note 2)

The collation device according to Supplementary Note 1, in which the collation means removes the reliability of at least one index among the plurality of indexes to collate the object, and the updating means updates a parameter that defines the frequency distribution of the removed at least one index.

### (Supplementary Note 3)

The collation device according to Supplementary Note 2, further including a degree calculation means for calculating a degree indicating strength of association between a past frequency distribution and a current frequency distribution for the removed at least one index, in which in a case where the degree is smaller than a threshold value, the updating means updates the parameter from a parameter defining the past frequency distribution to a parameter defining the current frequency distribution.

### (Supplementary Note 4)

The collation device according to Supplementary Note 2 or 3, further including an initial information generation means for generating initial information that is a past frequency distribution, from past target data, in which the updating means updates the parameter from a parameter defining the initial information to a parameter defining a current frequency distribution.

### (Supplementary Note 5)

A collation method including: updating, by a collation device, a parameter that defines a frequency distribution of one or a plurality of indexes relating to an object indicated by target data; calculating, by the collation device, reliability of each of the indexes, using the parameter; and collating, by the collation device, the object, based on the reliability.

### (Supplementary Note 6)

A program for causing a computer to execute: an updating process of updating a parameter that defines a frequency distribution of one or a plurality of indexes relating to an object indicated by target data; a reliability calculation process of calculating reliability of each of the indexes, using the parameter; and a collation process of collating the object, based on the reliability.

### [Supplementary Information 3]

Some or all of the above-described example embodiments may be further described as follows.

### (Supplementary Note 1)

A collation device comprising at least one processor, in which the at least one processor executes: an updating process of updating a parameter that defines a frequency distribution of one or a plurality of indexes relating to an object indicated by target data; a reliability calculation process of calculating reliability of each of the indexes, using the parameter; and a collation process of collating the object, based on the reliability.

(Supplementary Note 2) The collation device according to Supplementary Note 1, in which the at least one processor removes the reliability of at least one index among the plurality of indexes to collate the object in the collation process, and updates a parameter that defines the frequency distribution of the removed at least one index in the updating process.

### (Supplementary Note 3)

The collation device according to Supplementary Note 2, in which the at least one processor further executes a degree calculation process of calculating a degree indicating strength of association between a past frequency distribution and a current frequency distribution for the removed at least one index, and in a case where the degree is smaller than a threshold value, updates the parameter from a parameter defining the past frequency distribution to a parameter defining the current frequency distribution in the updating process.

### (Supplementary Note 4)

The collation device according to Supplementary Note 2 or 3, in which the at least one processor further executes an initial information generation process of generating initial information that is a past frequency distribution, from past target data, and updates the parameter from a parameter defining the initial information to a parameter defining a current frequency distribution in the updating process.

This collation device may further include a memory, and the memory may store a program for causing the processor to execute the updating process, the reliability calculation process, the collation process, the degree calculation process, and the initial information generation process. This program may be recorded in a non-transitory tangible computer-readable recording medium.

### REFERENCE SIGNS LIST

1, 20 collation device
11 updating unit
12 reliability calculation unit
13 collation unit
21 control unit
22 input unit
23 output unit
24 communication unit
25 storage unit
121 first reliability calculation unit
122 second reliability calculation unit
211 frequency distribution generation unit
212 degree calculation unit
fd frequency distribution
fr frame
pm parameter

What is claimed is:

1. A collation device comprising:
a memory configured to store instructions; and
one or more processors configured to execute the instructions to:
update a parameter that defines a frequency distribution of one or a plurality of indexes relating to an object indicated by target data;
calculate reliability of each of the indexes, using the parameter; and
collate the object, based on the reliability.

2. The collation device according to claim 1, wherein
the one or more processors are further configured to execute the instructions to:
remove the reliability of at least one index among the plurality of indexes to collate the object; and
update a parameter that defines the frequency distribution of the removed at least one index.

3. The collation device according to claim 2, wherein
the one or more processors are further configured to execute the instructions to:
calculate a degree indicating strength of association between a past frequency distribution and a current frequency distribution for the removed at least one index; and
in a case where the degree is smaller than a threshold value, update the parameter from a parameter defining the past frequency distribution to a parameter defining the current frequency distribution.

4. The collation device according to claim 2, wherein
the one or more processors are further configured to execute the instructions to:
generate initial information that is a past frequency distribution, from past target data; and
update the parameter from a parameter defining the initial information to a parameter defining a current frequency distribution.

5. A collation method comprising:
by a collation device,
updating a parameter that defines a frequency distribution of one or a plurality of indexes relating to an object indicated by target data;
calculating reliability of each of the indexes, using the parameter; and
collating the object, based on the reliability.

6. A non-transitory computer-readable recording medium storing a program for causing a computer to perform a method, the method comprising:
updating a parameter that defines a frequency distribution of one or a plurality of indexes relating to an object indicated by target data;
calculating reliability of each of the indexes, using the parameter; and
collating the object, based on the reliability.
